(19) United States
(12) Patent Application Publication
(10) Pub. No.: US 2024/0309172 A1
(43) Pub. Date: Sep. 19, 2024

(54) MASTERBATCH COMPOSITIONS WITH CARBON BLACK CARBON NANOTUBES

(71) Applicant: BIRLA CARBON U.S.A., Marietta, GA (US)

(72) Inventors: Ranjan K. Kamat, Marietta, GA (US); Douglas Barr, Marietta, GA (US); Kenneth Fritsch, Marietta, GA (US); Daniel Corella, Marietta, GA (US)

(21) Appl. No.: 18/681,250

(22) PCT Filed: Aug. 5, 2022
(86) PCT No.: PCT/US2022/039515

§ 371 Date: Feb. 5, 2024

Related U.S. Application Data
(60) Provisional application No. 63/230,288, filed on Aug. 6, 2021.

(51) Int. Cl. C08K 3/04; C08J 3/22; C09D 7/40; C09D 7/61

(52) U.S. Cl. CPC C08K 3/041; C08J 3/226; C09D 7/61; C09D 7/70; C08K 2201/003; C08K 2201/004; C08K 2201/006; C08K 2201/011; C08K 2201/014

(57) ABSTRACT

The present disclosure relates to masterbatch compositions comprising a base polymer and carbon black and carbon nanotubes as filler that can be used to prepare an article with improved electrical or mechanical performance relative to a masterbatch having carbon black filler alone. The masterbatch compositions can also be used to prepared colored articles without sacrificing electrical or mechanical performance as is typically seen with highly-loaded carbon black-filled compositions.

### CROSS-REFERENCE TO RELATED APPLICATIONS

This application claims priority to U.S. Provisional Application No. 63/230,288, filed Aug. 6, 2021, which is incorporated by reference in its entirety.

### BACKGROUND

### Technical Field

The present disclosure relates to masterbatch compositions comprising a base polymer and a carbon filler which can include carbon black and relatively small amounts of carbon nanotubes, methods of making the masterbatch compositions, and articles let down from the masterbatch compositions.

### Technical Background

Carbon blacks are used to develop conductive compounds but the acceptable range of conductivity or resistivity can only be achieved at very high loadings. At such high loadings, the physical properties of polymers are significantly deteriorated and the compounds become brittle. With the growing demand of automotive, electronic equipments, wearables and foldable electronics, both conductive and physical properties of compounds are very important. To overcome the problem with integrating carbon blacks into conductive compounds, compounders are using different methods such as including special additives and altering blend morphology. Such approaches technically challenging and lead to a significant rise in overall cost of the final product. As a result, there is a need for cost-efficient conductive filler system that can provide desired conductivity of carbon black compounds without compromising the physical properties of the polymer matrix. These needs and others are met by the present invention.

### SUMMARY

In accordance with the purpose(s) of the invention, as embodied and broadly described herein, this disclosure, in one aspect, relates to masterbatch compositions comprising a base polymer, carbon black, and carbon nanotubes.

In one aspect, the masterbatch composition comprises a base polymer and 20-70% by weight of a carbon filler. The carbon filler can comprise carbon black and carbon nanotubes, wherein the ratio of carbon black to carbon nanotubes is 70-99.5:30-0.5.

In a further aspect, the masterbatch composition comprises a base polymer and 20-70% by weight of a carbon black/carbon nanotube filler, wherein the carbon black has a nitrogen surface area (NSA) of 25-250 m2/g, as measured according to ASTM D6556 (2015).

Also disclosed are articles and coatings prepared from the disclosed masterbatch compositions.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications (including ASTM methods) mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a carbon nanotube” includes mixtures of two or more fillers, or carbon nanotubes, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

The term “masterbatch” means a mixture of the base polymer and a high concentration of carbon filler and other optional additives such as dispersing additives, pigments, dyes, colorants, and the like.

The term “base polymer” means the polymer into which a filler and any optional additive is mixed during the preliminary compounding step to form the masterbatch compositions.

The term “compounding” means the processing step during which the base polymer and the filler are mixed to form the masterbatch compositions.

The term “let down” means the processing step during which the masterbatch composition and the bulk polymer are mixed to form the final resin formulation. The term “bulk polymer” means the resin with which the masterbatch compositions are mixed to form a final resin formulation.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F. C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides for masterbatch compositions comprising carbon black and carbon nanotubes. The compositions are based on the unexpected discovery that carbon nanotubes, when combined with carbon black, are capable of imparting electrical percolation at much lower loadings than required with carbon black filler alone. For example, small amounts of carbon nanotubes can significantly enhance conductive performance of carbon black based coatings (e.g., acrylic coatings) as well as other articles and resins let down from the described masterbatch compositions. In addition, the combination of carbon black and carbon nanotubes allows for coatings and other articles to have a color other than black, while retaining sufficient electrical and mechanical properties. Ordinarily, the loading of carbon black necessary for achieving desired electrical or mechanical properties is such that an article or coating prepared from a carbon black filled masterbatch can only achieve a black color.

### A. Compositions

In one aspect, the masterbatch composition comprises a base polymer and 20-70% by weight of a carbon filler. The carbon filler can comprise carbon black and carbon nanotubes, wherein the ratio of carbon black to carbon nanotubes is 70-99.5:30-0.5. In a further aspect, the masterbatch composition comprises a base polymer and 20-70% by weight of a carbon black/carbon nanotube filler, wherein the carbon black has a nitrogen surface area (NSA) of 25-250 m²/g, as measured according to ASTM D6556 (2015). In some aspects, the masterbatch composition comprises 30-50% by weight of the carbon filler, e.g., 30%, 35%, 40%, 45%, or 50% by weight.

The addition of relatively small amounts of carbon nanotubes to the carbon black masterbatch compositions can result in unexpected improvement in electrical and mechanical properties of articles and coatings prepared or let down from the compositions. Thus, in one aspect, the ratio of carbon black to carbon nanotubes is 70-99.5:30-0.5 in the masterbatch composition. In a further aspect, the ratio of carbon black to carbon nanotubes is 85-98:15-2 in the masterbatch composition. In a still further aspect, the ratio of carbon black to carbon nanotubes is about 95:5 in the masterbatch composition. While allowing for sufficient electrical and mechanical properties, the addition of relatively small amounts of carbon nanotubes also permits articles and coatings prepared or let down from the masterbatch compositions to be colored, a result not typically achievable with masterbatch compositions having carbon black filler alone (the color of which tends to be limited to black).

The masterbatch compositions can optionally comprise a dispersing additive or other suitable additive. In one aspect, the masterbatch composition can comprise a dispersing additive in an amount ranging from 0.01% to 20% by weight. Other optional additives that can be present in the masterbatch compositions include without limitation pigments, dyes, or other materials for imparting color to an article or coating prepared from the masterbatch composition.

The compositions can be prepared according to any suitable method. In one aspect, the masterbatch composition can be prepared by melt-mixing, solution-blending, or a combination thereof. In one specific aspect, the masterbatch composition can be prepared by a two-step melt mixing method as further described in the Examples below.

### 1. Base Polymers

The masterbatch compositions can be used with a variety of base polymers. In general, any polymer that can be used as a carrier for a masterbatch composition can be used. Non-limiting examples include a thermoplastic polymer, thermosetting polymer, elastomeric polymer, or a combination thereof. Specific non-limiting examples include polyolefins such as polyethylene or polypropylene (e.g., Braskem PP D115A), polyamide, polystyrene, polyvinyl chloride, acrylonitrile butadiene styrene, polycarbonate, or other polymer, copolymer, or mixture thereof.

The surface resistivity of a polymeric material or article prepared or let down from the disclosed masterbatch compositions can be measured using a Loresta-GP (MCP-T600) or a Hiresta-UP (MCP-HT450) at 90V and 100V, respectively.

### 2. Carbon Black

The carbon black filler can comprise any suitable carbon black material. In one aspect, the carbon black filler can comprise a conductive or semi-conductive carbon black. In another aspect, the carbon black filler can comprise a high structure carbon black. High structure carbon black can increase compound viscosity, modulus, and conductivity. High structure can also reduce die swell, loading capacity, and improve dispersibility. Lower structure carbon blacks can decrease compound viscosity and modulus, increase elongation, die swell and loading capacity, but can also decrease dispersibility. If all other features of a carbon black are kept constant, narrow aggregate size distribution increases difficulty of carbon black dispersion and increases hysteresis and lowers resilience.

In one aspect, the carbon black has a nitrogen surface area (NSA) of 25-250 m²/g, as measured according to ASTM D6556 (2015). In a further aspect, the carbon black has a nitrogen surface area (NSA) of 40-90 m²/g, as measured according to ASTM D6556 (2015).

In a further aspect, the carbon black has an oil absorption number (OAN) of 45-250 cm³/100 g, as measured according to ASTM D2414 (2019). For example, the carbon black filler can comprise a carbon black having an oil absorption number of 45, 50, 60, 70, 80, 90, 100, 105, 110, 115, 120, 125, 130, 135, 140, 145, 150, 155, 160, 165, 170, 175, 180, 185, 190, 200, 220, 250 cc/100 g, as measured according to ASTM D2414 (2019). In a still further aspect, the carbon black has an oil absorption number (OAN) of 120-170 cm³/100 g, as measured according to ASTM D2414 (2019).

In various specific aspects, the carbon black can comprise Birla Carbon 7055, 7060, 7067, CONDUCTEX 7055 ULTRA, CONDUCTEX KU, CONDUCTEX SCU, RAVEN P, RAVEN P7U, or RAVEN PFEB carbon blacks, available from Birla Carbon, Marietta, Georgia USA.

The basic method for the production of carbon black is well known. Generally, carbon black is produced by the partial oxidation or thermal decomposition of hydrocarbon gases or liquids, where a hydrocarbon raw material (hereinafter called “feedstock hydrocarbon”) is injected into a flow of hot gas wherein the feedstock hydrocarbon is pyrolyzed and converted into a smoke before being quenched by a water spray. The hot gas is produced by burning fuel in a combustion section. The hot gas flows from the combustion section into a reaction section which is in open communication with the combustion section. The feedstock hydrocarbon is introduced into the hot gas as the hot gas flows through the reaction section, thereby forming a reaction mixture comprising particles of forming carbon black. The reaction mixture flows from the reactor into a cooling section which is in open communication with the reaction section. At some location in the cooling section, one or more quench sprays of, for example, water, are introduced into the flowing reaction mixture thereby lowering the temperature of the reaction mixture below the temperature necessary for carbon black production and halting the carbon formation reaction. The black particles are then separated from the flow of hot gas. A broad range of carbon black types can be made by controlled manipulation of the reactor conditions.

### 3. Carbon Nanotubes

Any suitable carbon nanotube can be used with the masterbatch compositions. In one aspect, the carbon nanotubes in the composition comprise multi-walled carbon nanotubes, single-walled carbon nanotubes, or a mixture thereof. The multi-walled carbon nanotubes, when present, can vary in diameter, aspect ratio, or purity.

In some aspects, the carbon nanotubes have an average diameter of 1.5-25 nm. In a further aspect, the carbon nanotubes have an average diameter of 9-15 nm. In one aspect, the carbon nanotubes have an average length of 1-50 μm. In a further aspect, the carbon nanotubes have an average length of 1.5-15 μm. A specific, non-limiting example of a carbon nanotube useful with the masterbatch compositions is NC7000, available from Nanocyl.

### B. Examples

Various exemplary embodiments of the invention are detailed below. These embodiments are intended to be exemplary and are not intended to limit the scope of the invention.

Procedure to prepare samples for examples 1-4: Conductive compounds containing CONDUCTEX 7055 ULTRA carbon black were prepared in two steps; first, a 30% C7055U masterbatch in a polypropylene (Braskem PP D115A) resin was prepared using a twin-screw extruder (16 mm, 25:1) at 230° C.; second, the 30% masterbatch was mixed with a virgin polypropylene (Braskem PP D115A) resin using a twin-screw extruder (16 mm, 25:1) at 230° C. to achieve the desired final loading of carbon black.

Procedure to prepare samples for example 5-9, 27-30; CNT containing compounds were prepared by either first encapsulating the powder CNT in polymer resin using a mini-extruder at higher loading and then letdown to desired loadings with a twin-screw extruder, or a commercial CNT masterbatch was mixed with virgin resin to achieve target loadings on a twin-screw extruder.

Procedure to prepare samples for example 10-26, 31-33: Conductive carbon black-CNT blends were prepared by two approaches: powder blending and masterbatch approach. Powder blending—In the case of powder blending, carbon black and CNTs were dry-mixed in a specific ratio. The dry-mixed sample was then compounded with polymer resin using a mini-extruder. Masterbatch blending—In the masterbatch approach, a CNT masterbatch was prepared by compounding CNTs with polymer resin, or a commercial CNT masterbatch was used. The CNT masterbatch was then mixed with virgin resin and carbon black to achieve the desired loadings in the final compound.

Procedure to prepare samples for example 34-42: To evaluate mechanical properties, compounding was performed in two steps. Step 1: samples were first compounded using one of the aforementioned procedures in a twin-screw extruder (16 mm, 25:1). Step 2: The compound was granulated then fed into a single-screw injection mold machine. Samples were injection molded at 230° C. into the form of tensile bars.

Procedure to prepare samples for conductivity test: Test samples, 1 mm×2.54 cm tape strands, were prepared using a tape header on a twin-screw extruder.

Procedure to test surface conductivity: Surface resistivity was measured using a Loresta-GP (MCP-T600) and a Hiresta-UP (MCP-HT450) at 90V and 100V, respectively.

Procedure to analyze samples using TEM: TEM samples were prepared by ultra-microtome.

Procedure to evaluate mechanical properties: Mechanical properties were evaluated according to ASTM D638 (2015) using a universal tensile tester with a separation rate of 2 in/min.

Results and discussion: Comparing the surface resistivity of polymer compounds from Examples 4, 13, and 16, Example 9 (which contains the carbon nanotube (CNT)) shows significantly lower surface resistivity, suggesting that the addition of CNT imparts desirable conductivity to polymeric materials. The improvement in conductive performance is synergistic in nature. At 1% CNT loading, resistivity is greater than 1.00 E+15, and for carbon black at 10% and 15% loadings, the resistivity is also greater than 1.00 E+15. But with addition of 0.3% CNT in the 15% carbon black compound and 0.75% CNT in the 10% carbon black compound, the resistivity is below 1.45 E+07. The difference in surface resistivity of Example 21 and Example 25 can be attributed to a difference in the compounding protocol.

TABLE 1
Surface Resistivity of Polypropylene Compounds containing carbon
black (CB) and Multiwalled Carbon Nanotube (MWCNT).

| | | Surface |
|---|---|---|
| Sample | Composition | Resistivity (Ω/□) |
| Example 1 | 10% C7055U | >1.00 E+15 |
| Example 2 | 15% C7055U | >1.00 E+15 |
| Example 3 | 20% C7055U | 2.97 E+02 |
| Example 4 | 25% C7055U | 3.81 E+02 |
| Example 5 | 0.5% MWCNT | >1.00 E+15 |
| Example 6 | 1% MWCNT | >1.00 E+15 |
| Example 7 | 1.5 MWCNT | 2.21 E+08 |
| Example 8 | 2% MWCNT | 1.06 E+04 |
| Example 9 | 3% MWCNT | 2.65 E+02 |
| Example 10 | 10% C7055U + 0.5% MWCNT | 2.51 E+13 |
| Example 11 | 10% C7055U + 0.75% MWCNT | 1.11 E+04 |
| Example 12 | 10% C7055U + 1.0% MWCNT | 1.15 E+03 |
| Example 13 | 10% C7055U + 2.0% MWCNT | 1.14 E+02 |
| Example 14 | 15% C7055U + 0.2% MWCNT | 1.23 E+10 |
| Example 15 | 15% C7055U + 0.3% MWCNT | 1.45 E+07 |
| Example 16 | 15% C7055U + 0.5% MWCNT | 2.30 E+02 |
| Example 17 | 15% C7055U + 1.0% MWCNT | 8.81 E+01 |
| Example 18 | 15% C7055U + 2.0% MWCNT | 3.60 E+01 |

The CB-CNT masterbatch can be prepared by both powder blending and masterbatch blending methods. The CB-CNT masterbatch prepared by powder blending methods showed better ability to impart conductivity to polymer matrix than CB-CNT MB prepared by masterbatch blending methods, as demonstrated by the data in Table 2.

TABLE 2
Surface Resistivity of Polypropylene Compounds containing carbon
black (CB), Multiwalled Carbon Nanotube (MWCNT).

| | | Surface |
|---|---|---|
| | | Resistivity |
| Sample | Composition | (Ω/□) |
| Example 19 | 6.25% 95-5 CB-MWCNT (Powder Blend) | >1.00 E+15 |
| Example 20 | 7.5% 95-5 CB-MWCNT (Powder Blend) | >1.00 E+15 |
| Example 21 | 10% 95-5 CB-MWCNT (Powder Blend) | 3.01 E+05 |
| Example 22 | 12.5% 95-5 CB-MWCNT (Powder Blend) | 3.40 E+02 |
| Example 23 | 6.25% 95-5 CB-MWCNT (MB Blend) | >1.00 E+15 |
| Example 24 | 7.5% 95-5 CB-MWCNT (MB Blend) | >1.00 E+15 |
| Example 25 | 10% 95-5 CB-MWCNT (MB Blend) | 8.16 E+12 |
| Example 26 | 12.5% 95-5 CB-MWCNT (MB Blend) | 8.45 + 03 |

As demonstrated by Examples 27-33, the CB-CNT masterbatch can be prepared by using CNTs from different manufacturers. The ability of the CNTs from different manufacturers to perform similarly indicate the synergistic nature of the CB and CNT blend system where CB helps to achieve better dispersion of CNT, and CNTs help to develop a more connected path for electron flow. These data demonstrate that CNT can be blended together to develop a CB-CNT masterbatch for high-performance materials.

TABLE 3
Surface Resistivity of Polypropylene Compounds containing carbon
black (CB), Multiwalled Carbon Nanotube (MWCNT).

| | | Surface |
|---|---|---|
| | | Resistivity |
| Sample | Composition | (Ω/□) |
| Example 27 | 1% BT1003M MWCNTs | >1.00 E+15 |
| Example 28 | 1.5% BT1003M MWCNTs | 1.69 E+05 |
| Example 29 | 2% BT1003M MWCNTs | 5.88 E+02 |
| Example 30 | 3% BT1003M MWCNTs | 1.53 E+02 |
| Example 31 | 5% 95-5 C7055U-BT1003M (Powder Blend) | >1.00 E+15 |
| Example 32 | 7.5% 95-5 C7055U-BT1003M (Powder Blend) | 6.11 E+14 |
| Example 33 | 10% 95-5 C7055U-BT1003M (Powder Blend) | 1.65 E+03 |

Mechanical Properties: Properties of Polypropylene Compounds containing carbon black (CB), and Carbon Nanotube (CNT) were measured. Carbon black and CNT were mixed in powder form and fed together during compounding. TSE with L/D of 40 was used for compounding. The results are shown in Table 4.

TABLE 4
Mechanical Properties (Elongation retention percentage) of
Polypropylene Compounds containing carbon black (CB) and
Multiwalled Carbon Nanotube (MWCNT).

| Sample | Composition | Elongation Retention (%) |
|---|---|---|
| Example 34 | 15% C7055U | 44.97 |
| Example 35 | 20% C7055U | 33.18 |
| Example 36 | 0.5% MWCNT | 88.67 |
| Example 37 | 1% MWCNT | 89.70 |
| Example 38 | 2% MWCNT | 78.15 |
| Example 39 | 3% MWCNT | 76.32 |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A masterbatch composition comprising:
a) a base polymer:
b) 20-70% by weight of a carbon filler, the carbon filler comprising carbon black and carbon nanotubes, wherein the ratio of carbon black to carbon nanotubes is 70-99.5:30-0.5.

2. The composition of claim 1, wherein the base polymer is a thermoplastic polymer, thermosetting polymer, elastomeric polymer, or a combination thereof

3. The composition of claim 1, comprising 30-50% by weight of the carbon filler.

4. The composition of claim 1, wherein the ratio of carbon black to carbon nanotubes is 85-98:15-2.

5. The composition of claim 1, wherein the ratio of carbon black to carbon nanotubes is about 95:5.

6. The composition of claim 1, wherein the carbon black has a nitrogen surface area (NSA) of 25-250 m²/g, as measured according to ASTM D6556 (2015).

7. The composition of claim 6, wherein the carbon black has a nitrogen surface area (NSA) of 40-90 m²/g, as measured according to ASTM D6556 (2015).

8. The composition of claim 1, wherein the carbon black has an oil absorption number (OAN) of 45-250 cm³/100 g, as measured according to ASTM D2414 (2019).

9. The composition of claim 8, wherein the carbon black has an oil absorption number (OAN) of 120-170 cm³/100 g, as measured according to ASTM D2414 (2019).

10. The composition of claim 1, wherein the carbon nanotubes are multi-walled carbon nanotubes, single-walled carbon nanotubes, or a combination thereof.

11. The composition of claim 1, wherein the carbon nanotubes have an average diameter of 1.5-25 nm.

12. The composition of claim 11, wherein the carbon nanotubes have an average diameter of 9-15 nm.

13. The composition of claim 1, wherein the carbon nanotubes have an average length of 1-50 μm.

14. The composition of claim 13, wherein the carbon nanotubes have an average length of 1.5-15 μm.

15. A masterbatch composition comprising:
a) a base polymer;
b) 20-70% by weight of a carbon filler, the carbon filler comprising carbon black and carbon nanotubes, wherein the carbon black has a nitrogen surface area (NSA) of 25-250 m²/g, as measured according to ASTM D6556 (2015).

16. The composition of claim 15, wherein the base polymer is a thermoplastic polymer, thermosetting polymer, elastomeric polymer, or a combination thereof.

17. The composition of claim 15, comprising 30-50% by weight of the carbon filler.

18. The composition of claim 15, wherein the ratio of carbon black to carbon nanotubes is 70-99.5:30-0.5.

19. The composition of claim 18, wherein the ratio of carbon black to carbon nanotubes is 85-98: 15-2.

20. (canceled)

21. (canceled)

22. (canceled)

23. (canceled)

24. (canceled)

25. (canceled)

26. (canceled)

27. (canceled)

28. (canceled)

29. An article or coating prepared or let down from the masterbatch composition of claim 1.
